(19) United States
(12) Patent Application Publication
(10) Pub. No.: US 2003/0219263 A1
(43) Pub. Date: Nov. 27, 2003

(54) Toner supply device for use in image forming system and method for supplying toner thereto

(75) Inventor: Seiji Tsuzuki, Kawaguchi-Shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/153,872

(22) Filed: May 24, 2002

(51) Int. Cl. G03G 15/08

(52) U.S. Cl. 399/27; 399/258

(57) ABSTRACT

A toner supply device used for an image forming system for forming images with toner is provided for supplying the toner to the image forming system from a toner cartridge. The toner cartridge has a cylindrical container with a spiral protrusion being formed on the inner surface of the cylindrical container and with a toner-discharging hole being formed on the outer surface of one of two capped end sections of the cylindrical container. The toner supply device has a cartridge holder installed in the image forming system, to hold the toner cartridge in a horizontal direction, the toner cartridge being rotatable while held by the cartridge holder, a rotation driver to supply a rotary power to the toner cartridge, thus the toner being supplied to the image forming system through the toner-discharging hole due to a weight of the toner when the toner-discharging hole is facing downwards during rotation of the toner cartridge, a counter which counts rotation number for each of newly installed toner cartridge, and a controller which monitors the amount of the toner remaining in the toner cartridge to control the rotation driver to vary a rotational speed of the toner cartridge within one rotation using the accumulated amount of the count counted by the counter.

### BACKGROUND OF THE INVENTION

The present invention relates to a toner supply device used in an image forming system such as a facsimile machine and a printer.

An image forming system develops a latent image of a desired image on a photosensitive drum as an image-carrying body with toner supplied from a developing device, thus forming the desired image. Toner is supplied from a toner supply device to the developing device of the image forming system. For example, a toner cartridge having a cylindrical toner bottle containing toner is installed in the toner supply device. Toner is discharged through a toner-discharging hole provided at an end of the toner bottle while the toner cartridge is rotating and supplied to the developing device of the image forming system via a toner hopper. This type of toner supply device has a problem in that, as the amount of toner remaining in the toner bottle decreases, the amount of toner to be supplied to the toner hopper is not enough for developing the latent image.

A known technique for solving such problem is to rotate a toner bottle at high speed for steady toner supply to a developing device when a detecting means such a sensor detects that toner in a toner hopper is in short supply.

The known technique, however, requires an expensive sensor, thus causing inevitable cost up for a toner supply device and also an image forming system. This known technique is further disadvantageous in that toner could be in short supply during for example high-speed continuous formation of a large number of images and formation of a single image but consuming a lot of toner in case of such as a manuscript including so called “solid” portion.

### SUMMARY OF THE INVENTION

A purpose of the present invention is to provide a toner supply device and a toner supply method for steady supply of constant amount of toner to an image forming system, with simple and low-cost configuration, thus solving such problems in the known technique.

According to a first aspect of the present invention, there is provided a toner supply device used for an image forming system for forming images with toner, for supplying the toner to the image forming system from a toner cartridge having a cylindrical container, at least, a spiral protrusion being formed on the inner surface of the cylindrical container and a toner-discharging hole being formed on the outer surface of one of two capped end sections of the cylindrical container, the toner supply device comprising: a cartridge holder which is installed in the image forming system to hold the toner cartridge in a horizontal direction, the toner cartridge being rotatable while held by the cartridge holder; a rotation driver which supplies a rotary power to the toner cartridge, thus the toner being supplied to the image forming system through the toner-discharging hole due to a weight of the toner while the toner-discharging hole is facing downwards during rotation of the toner cartridge; and a controller which controls the rotation driver to vary a rotational speed of the toner cartridge within one rotation in accordance with an amount of the toner remaining in the toner cartridge.

According to a second aspect of the present invention, there is provided a toner supply device used for an image forming system for forming images with toner, for supplying the toner to the image forming system from a toner cartridge having a cylindrical container with a spiral protrusion being formed at least on the inner surface of the cylindrical container and a toner-discharging hole being formed on the outer surface of one of two capped end sections of the cylindrical container, the toner supply device comprising: a cartridge holder installed in the image forming system to hold the toner cartridge in a horizontal direction allowing the toner cartridge to be rotated; a rotation driver to supply a rotary power to the toner cartridge, thus the toner being supplied to the image forming system through the toner-discharging hole due to a weight of the toner while the toner-discharging hole is facing downwards during rotation of the toner cartridge; a hopper to be supplied with the toner due to a weight of the toner while the toner-discharging hole is facing downwards during rotation of the toner cartridge and to mix the toner with carrier at a specific mixing ratio, the mixed toner and carrier being supplied to the image forming system; and a controller to control the rotation driver to vary a rotational speed of the toner cartridge within one rotation in accordance with an amount of the toner remaining in the toner cartridge.

According to a third aspect of the present invention, there is provided a toner supply device used for an image forming system for forming latent images of desired images on an image-carrying body and developing the latent images into the desired images with toner supplied from a developing device onto the image-carrying body, for supplying the toner to the developing device from a toner cartridge having a cylindrical container with a spiral protrusion being formed at least on the inner surface of the cylindrical container and a toner-discharging hole being formed on the outer surface of one of two capped end sections of the cylindrical container, the toner supply device comprising: a cartridge holder installed in the image forming system, which holds the toner cartridge in a horizontal direction allowing the toner cartridge to be rotated; a rotation driver which supplies a rotary power to the toner cartridge; a hopper which is supplied with the toner due to a weight of the toner while the toner-discharging hole is facing downwards during rotation of the toner cartridge and to mix the toner with carrier, the mixed toner and carrier being supplied to the developing device; and a controller which controls the rotation driver to vary a rotational rotational speed of the toner cartridge in accordance with an amount of the toner remaining in the toner cartridge.

According to a fourth aspect of the present invention, there is provided a toner supply method used for an image forming system for forming images with toner, for supplying the toner to the image forming system from a toner cartridge having a cylindrical container with a spiral protrusion being formed at least on the inner surface of the cylindrical container and a toner-discharging hole being formed on the outer surface of one of two capped end sections of the cylindrical container, the toner supply method comprising the steps of: supplying a rotary power to the toner cartridge, thus the toner being supplied to the image forming system through the toner-discharging hole due to a weight of the toner when the toner-discharging hole is facing downwards during rotation of the toner cartridge; and varying a rotational speed of the toner cartridge within one rotation in accordance with an amount of the toner remaining in the toner cartridge.

### BRIEF DESCRIPTION OF THE DRAWINGS

In the drawings:

FIG. 1 is a sectional view showing the whole construction of a copying machine as an image forming system, to which a toner supply device according to the present invention is applied;

FIG. 2 is a schematic diagram showing a principal part of the image forming system shown in FIG. 1;

FIG. 3 is an exploded perspective view showing the details of a cylindrical container and cap constituting a toner cartridge;

FIG. 4 is an exploded perspective view showing a drive unit of a toner supply device;

FIG. 5 is a perspective view showing a toner cartridge while being inserted into an inlet holder;

FIG. 6 is a sectional view showing a toner cartridge immediately before being attached;

FIGS. 7A through 7C are sectional views showing the operation of detaching a toner cartridge;

FIG. 8 is a perspective view illustrating the installation of a toner cartridge and a drive unit together with a holder;

FIG. 9 is a block diagram showing a schematic configuration of a toner supply device, an embodiment according to the present invention;

FIG. 10 is a flowchart showing a procedure for counting the rotation number of the toner cartridge;

FIG. 11 is a flowchart showing a procedure for controlling motor rotation in accordance with an accumulated count value of the rotation number of the toner cartridge;

FIG. 12 is a flowchart showing a detailed procedure for the first low-speed rotation control 1 shown in FIG. 11;

FIG. 13 is a flowchart showing a detailed procedure for the second low-speed rotation control 2 shown in FIG. 11; and

FIG. 14 is a flowchart showing a detailed procedure for the third low-speed rotation control 3 shown in FIG. 11.

### DESCRIPTION OF THE PREFERRED EMBODIMENT

Referring to the attached drawings, some embodiments for toner supply device and method of supplying toner to an image forming system will be described below. In the following description for the embodiments, a copying machine is taken for instance of an image forming system, and a toner supply device and a method of supplying toner for this copying machine will be described with detailed with construction of the image forming system.

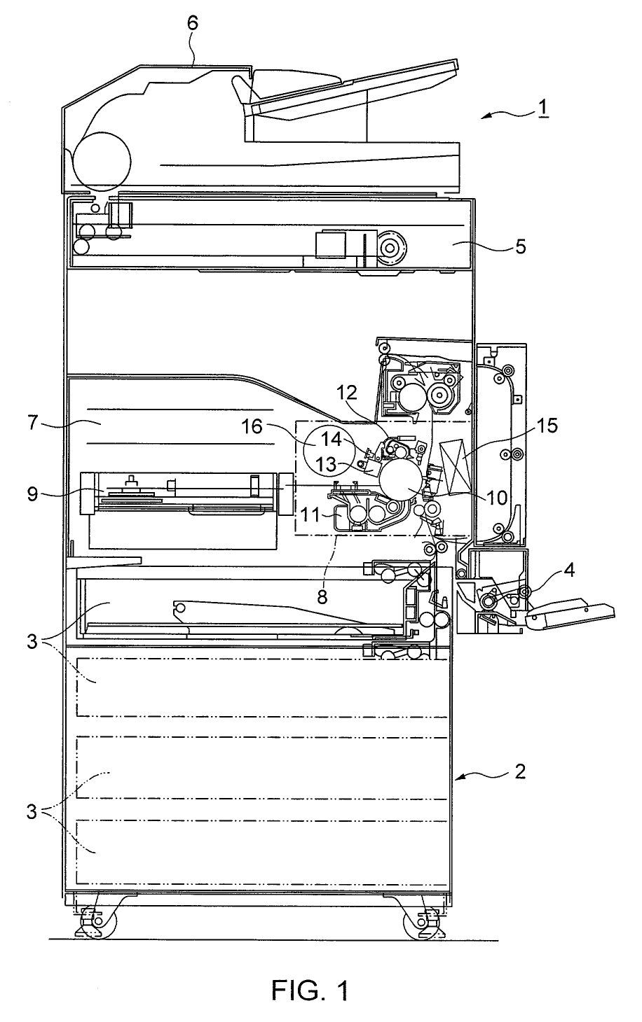

FIG. 1 is a sectional view showing the whole construction of a copying machine, in which a toner supply device according to the present invention is provided. In FIG. 1, a copying machine 1 has a paper feeding cassette device 2 for housing therein a large number of papers, in the lower portion of the body thereof. The copying machine 1 also has an LCF paper feeding device 3 for feeding a large number of papers having the same size, and a manual paper feeding device 4 capable of manually feeding various kinds of papers having various sizes.

The copying machine 1 comprises: an image reading part 5, provided in the upper portion, for reading a manuscript; an automatic manuscript feeding device 6 for feeding the manuscript to the image reading part 5; an image storing part 7 for storing image data read by the image reading part 5; and an optical laser system 9 for deriving the stored image data to write an image to be printed, in an image forming part 8.

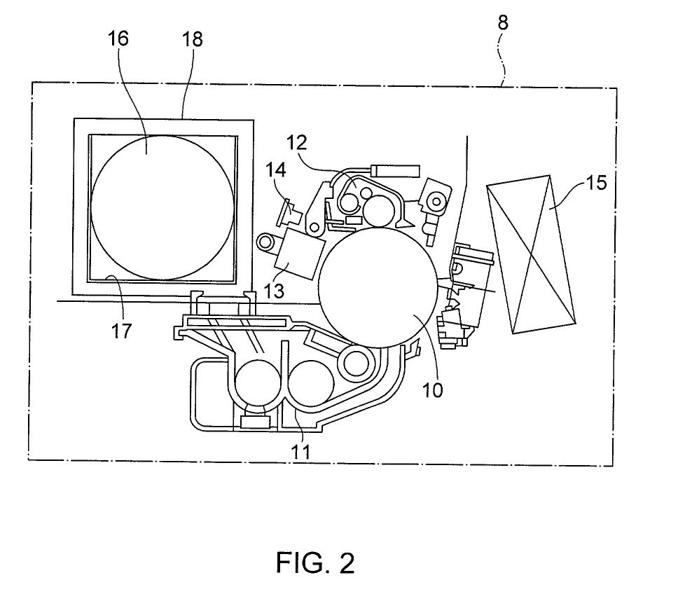

As shown in FIG. 2 in addition to FIG. 1, the image forming part 8 comprises a photosensitive material drum 10, a developing device 11, a cleaner 12, a charger 13, a charge-removing lamp 14, and a transfer/peeling charger 15. On the developing device 11, a toner cartridge 16 for supplying a toner, and a driving part 17 (not shown in FIGS. 1 and 2) for rotating the toner cartridge 16 are attached.

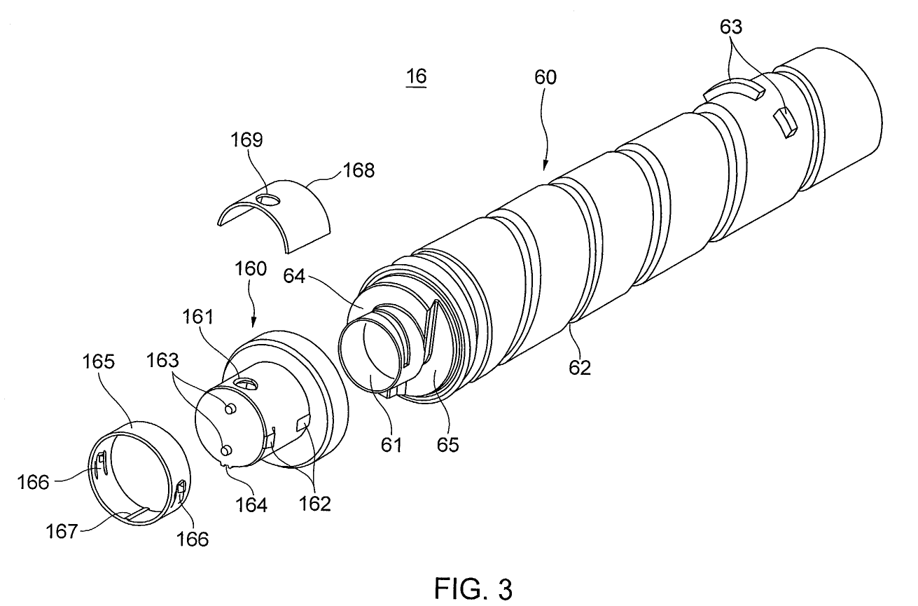

Referring to FIG. 3, the detailed construction of the toner cartridge 16 will be described. In FIG. 3, the toner cartridge 16 comprises a cylindrical container 60 serving as a body, a cap 160 serving as a toner discharging part, and a discharging hole shielding cover 165.

The cylindrical container 60 has a cylindrical shape with a bottom. At least on the inner peripheral surface of the cylindrical container 60, there is formed a spiral protrusion (not shown) for gradually feeding a toner, which is previously filled, toward an opening portion 61 as the cylindrical container 60 rotates. In a preferred embodiment shown in FIG. 3, the cylindrical container 60 is formed of a synthetic resin by the blow molding, so that a spiral groove 62 is formed in the outer peripheral surface of the cylindrical container 60 so as to correspond to the spiral protrusion for guide.

At a predetermined position spaced from the bottom of the cylindrical container 60, there are provided positioning portions 63 for positioning the outer periphery of the cylindrical container 60. In the preferred embodiment shown in FIG. 3, two positioning portions 63 are formed as protrusions by removing a part of a peripheral flange.

The opening portion 61 of the cartridge 16 is formed at the center of a stepped portion 64 and projects therefrom so as to have a predetermined diameter. A part of the stepped portion 64 is formed with a positioning cut-out portion 65 for integrating the container 60 with the cap 160 so as to establish a predetermined relationship between the positions of a discharging hole 161, which will be described later, and the positioning portions 63 when the cap 160 is mounted on the cylindrical container 60.

The cap 160 has a shape having a stepped portion, which corresponds to the shape of the periphery of the opening portion 61 of the cylindrical container 60, as a whole. The cap 160 has the discharging hole 161 at an arbitrary position on the peripheral wall thereof. The cap 160 is provided for supplying one dose of the toner when the cap 160 is rotated by a half rotation from the initial position to face downwards during the rotation of the toner cartridge 16 after the cap 160 is mounted on the cylindrical container 60. At positions shifted from the discharging hole 161 by 90 degrees in the peripheral wall surface, two engaging portions (protrusions) 162a and 162b for engaging a discharging hole shielding cover 165, which will be described later, are provided on each of both sides. Although only the engaging portions 162a and 162b on one side are shown in FIG. 3, other two engaging portions 162a and 162b are provided at positions shifted from the engaging portions 162a and 162b on the shown side by 180 degrees. As will be described in detail later, a groove 162c is formed between the two engaging portions 162a and 162b, and the cover 165 is designed to move in the groove 162c in axial directions to contact the engaging portions 162a and 162b.

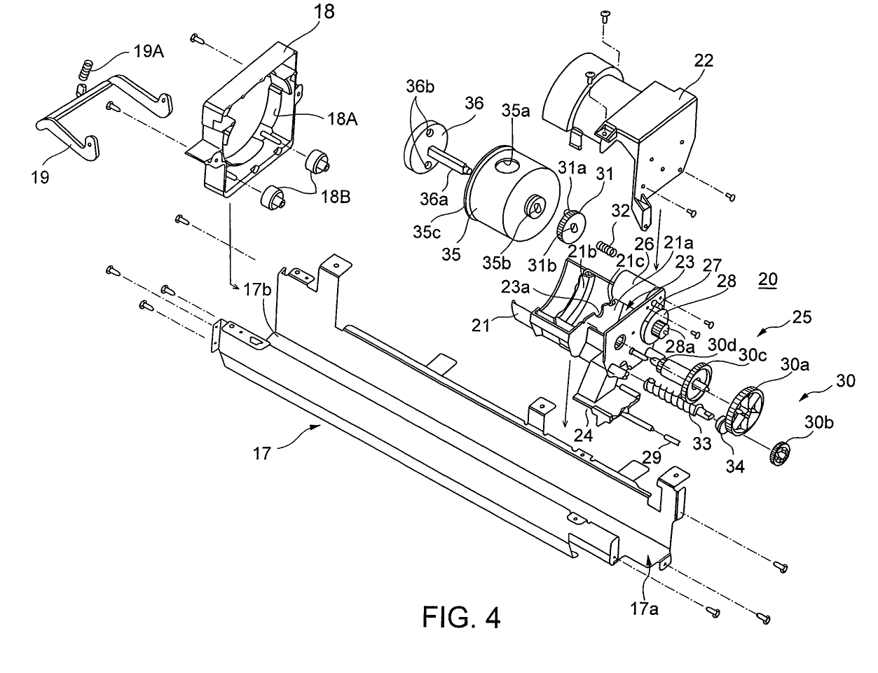

On the tip flat surface of the cap 160, there are provided protruding portions 163 serving as positioning portions for engaging positioning recessed portions (not shown) formed in a flat surface of the inner wall of a holder guide of a drive unit 20, which will be described later, to inhibit the rotational shift between the holder guide and the toner cartridge 16. In this preferred embodiment, the protruding portions 163 are formed by two bosses arranged in the radial directions corresponding to the position of the discharging hole 161. In addition, the protruding portions 163 serve to rotate the cylindrical container 60 while receiving the torque of a motor 26 (FIG. 4) which will be described later. On the opposite side of the discharging hole 161 in the radial direction in the peripheral wall of the cap 160, a guide groove 164 for guiding the axial movement of the cover 165 is formed so as to extend in axial directions.

The cover 165 for shielding and opening the discharging hole 161 has a ring shape having a predetermined diameter and a predetermined width which is greater than the diameter of the discharging hole 161. The cover 165 facing the engaging portions 162a and 162b of the cap 160 and grooves 162c has protrusions for engaging the engaging portions 162a and 162b, and elastic spring portions 166 formed by forming U-shaped cut-outs in the periphery thereof. That is, the U-shaped cut-outs are formed in the cover 165 in circumferential directions thereof to form elastic tongue pieces 166 serving as cantilevers, and inner stoppers 166a are formed on the internal and external surfaces of the tongue pieces 166 so as to be movable in the grooves 162 of the cap 160 in axial directions to abut on the protrusions 162a and 162b.

Moreover, as described above, a protruding portion 167 protruding from the inner peripheral surface of the cover 165 to extend in axial directions thereof is provided so as to correspond to the guide groove 164 of the cap 160. The protruding portion 167 is positioned by the guide groove 164 so that the cover 165 is slidable along the peripheral surface of the cap 160.

Although the discharging hole 161 is opened and closed by the sliding of the cover 165, there is a slight gap between the outer peripheral surface of the cap 160 and the inner peripheral surface of the cover 165. In order to prevent the toner from leaking from the gap while shielding the discharging hole 161, a seal 168 of an elastic material, such as felt or sponge, is applied on a portion surrounding the discharging hole 161. The seal 168 has a through hole 169 formed so as to correspond to the discharging hole 161. The construction of the toner cartridge has been described above.

Referring to FIG. 4, the construction of the drive unit 20 for rotating the above described toner cartridge 16 will be described below.

Briefly, the torque of the motor 26 is transmitted to a disk (driving plate) 36 to rotate the toner cartridge 16 since the protruding portions 163 of the toner cartridge 16 are inserted into recessed grooves (driving holes) 36b, 36b formed in the disk 36. In addition, a carrier auger 33 is rotated by the motor 26 to move the toner from a chamber 23 to a hopper 24. The detailed construction of the drive unit 20 will be described below.

In FIG. 4, a cartridge receiving portion 17 is secured to the body of the copying machine 1, and is a substantially U-shaped receiving member of a metal or synthetic resin. The drive unit 20 is mounted on an end portion 17a of the U-shaped receiving portion 17 on the front side in the figure. A rectangular inlet guide 18 is secured to the other end portion 17b of the receiving portion 17 by means of a screw or the like. The inlet guide 18 has a guide hole 18A having a diameter capable of receiving the toner cartridge 16, and two rollers 18B are arranged along the periphery of the insertion opening 18A for rotatably supporting the toner cartridge 16.

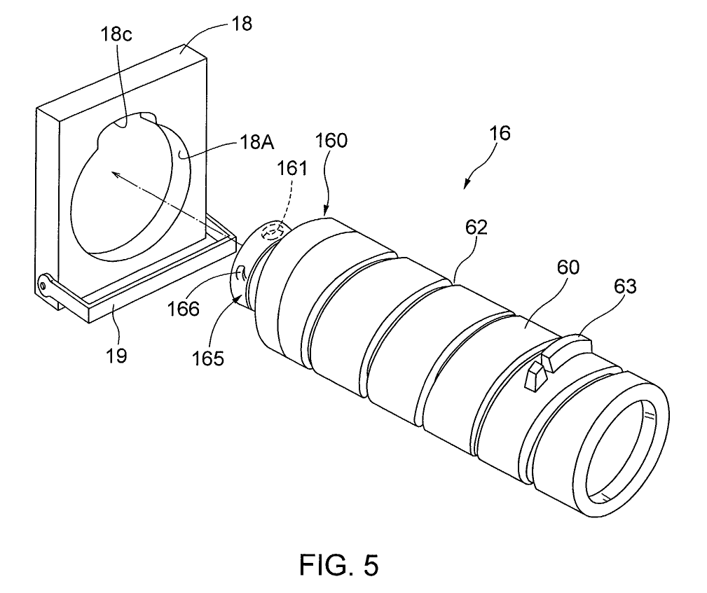

On the inlet guide 18, there is mounted a substantially C-shaped biasing lever 18 for biasing the bottom of the cylindrical container 60 toward the drive unit 20 after the toner cartridge 16 is attached. The biasing lever 19 biases the cylindrical container 60, which is inserted by a spring 19A in horizontal directions, toward the drive unit 20 from the guide 18. FIG. 5 is a perspective view schematically showing the inlet holder 18, the biasing lever 19 and the toner cartridge 16 when the toner cartridge 16 is inserted into the inlet holder 18. As shown in this figure, on the upper side of the inner peripheral surface of the insertion opening 18A of the inlet holder 18, there is formed a recessed portion 18C engaging the protruding positioning portion 63 of the cylindrical container 60, i.e., allowing the insertion and extraction of the toner cartridge 16.

As shown in FIG. 4, the drive unit 20 comprises: a substantially semi-cylindrical holder 21; a holder cover 22 integrated with the holder 21 for forming a cylinder which is open toward the inlet guide 18; a chamber 23 defined by the holder 21 and the holder cover 22; a hopper 24 for supplying a toner, which is filled in the chamber 23, to the developing device 11; and a drive mechanism 25 arranged in the vicinity of the chamber 23. The holder 21 and the holder cover 22 have a shape formed by dividing a cylinder along a radius. The holder 21 has a partition wall 21a defining the chamber 23, and an engaging partition wall 21b engaging a flange portion 35c of a holder guide 35 which will be described later. The partition wall 21a has a cut-out 21c which is associated with a facing partition wall (not shown) of the holder cover 22 for forming a hole.

The drive mechanism 25 comprises a motor 26 serving as a driving source, a belt 27, a pulley 28, drive gear sets 30, 31, a spring 32, a carrier auger 33 for promoting the movement of the toner from the chamber 23 to the hopper 24, a bush 34, a holder guide 35 and a disk 36. Furthermore, reference number 29 denotes a spring mounted on a pin of a cover of the hopper 24. The drive gear set 30 comprises: a large-diameter first gear 30a; a second gear 30b which meshes with the first gear 30a and which is mounted on the carrier auger 33 via the bush 34; a third gear 30c which meshes with a gear 28a integrated with the pulley 28 outside of the chamber 23; and a fourth gear 30d mounted on one end of a shaft, on the other end of which the third gear 30c is mounted. The fourth gear 30d is arranged in the chamber 23, and is designed to mesh with the gear set 31 fixed to the holder guide 35.

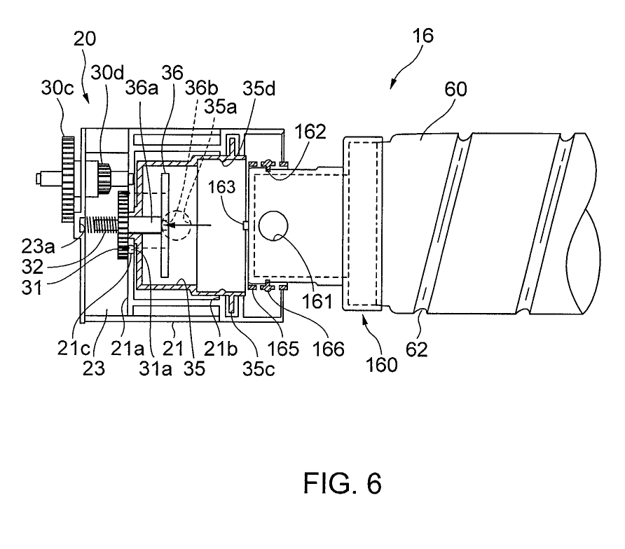

The holder guide 35 is a cup-shaped member having a diameter which is a size larger than that of the cylindrical portion at the tip of the cap 160 of the toner cartridge 16 shown in FIG. 3. The holder guide 35 has a supply hole 35a which is formed so as to have a diameter corresponding to the discharging hole 161 of the cap 160 and to correspond to the position of the discharging hole 161 of the cap 160. The central portion of the bottom of the holder guide 35 protrudes in the form of a boss, in which an elliptically shaped hole 35d is formed. The disk 36 has a shaft 36a having a D-shaped cross section, which passes through the elliptically shaped hole 35b of the holder guide 35, and holes or recessed portions 36b formed in the disk 36 on a center line defining a diameter thereof at positions which are symmetrical with respect to the center line, the center of which corresponds to the center point of the flat surface of the shaft 36a. Furthermore, reference number 35c denotes a flange portion for causing the holder guide 35 to engage the holder 21, and reference number 35d shown in FIG. 6 denotes an engaging protrusion engaging the cover 165 of the cap 160 to open the discharging hole 161.

The recessed portion 36b has a shape and size so as to engage the protruding portion 163 protruding from the tip end surface of the cap 160 of the toner cartridge 16. When the protruding portion 163 and the shaft 36a engage the recessed portion 36b and the D-shaped hole 35b, respectively, the toner cartridge 16 and the holder guide 35 are integrally rotated while at least the rotational shift therebetween is inhibited. In addition, the gear set 31 has a protrusion 31a engaging a hole which is formed by the cut-out 21c formed in the partition wall 21a of the holder 21, and the cut-out (not shown) of the holder guide 22 facing the cut-out 21c, and an elliptically shaped hole 31b having a shape corresponding to the elliptically shaped hole 35b of the holder guide 35. The tip portion of the shaft 36a of the disk 36 passes through the elliptically shaped holes 35b and 31b to engage the spring 32 while playing therewith, so that the shaft 36a rotatably engages a shaft receiving portion 23a formed in the inner wall of the chamber 23. The shaft receiving portion 23a is shown in the sectional view of FIG. 6 although it is not shown in the exploded perspective view of FIG. 4.

The respective parts with the above described constructions are previously assembled except for the toner cartridge 16. The drive unit 20 is assembled to be mounted on the one end side 17a of the cartridge receiving portion 17, and the inlet holder 18 having the biasing lever 19 is mounted on the other end portion 17b. The drive mechanism 25 of the drive unit 20 is mounted on the inside and outside of the chamber 23 separated by the partition wall 21a of the holder 21, to constitute the gear systems 30 and 31. The holder guide 35 is provided between the partition wall 21a of the holder 21 and the engaging partition wall 21b engaging the flange portion 35c of the holder guide 35 while the disk 36 of the holder guide 35 is mounted. After all of the parts are combined with the holder 21, the holder 21 is covered with the holder cover 22 to be fixed by the shown screw to be assembled, and thereafter, the assembly is fixed to the one end side 17a of the cartridge receiving portion 17.

Referring to FIGS. 5 through 7C, the operations for attaching and detaching the toner cartridge 16 on and from the toner supply device with the above described construction will be described. First, in order to attach the toner cartridge 16 on the drive unit 20, the toner cartridge 16 is horizontally waggled to be sufficiently shaken, the toner cartridge 16 is then inserted into the guide hole 18A of the inlet holder 60 from the side of the cap 160 as shown in FIG. 5. At this time, by inserting the toner cartridge 16 so that the protruding positioning portion 63 of the cylindrical container 60 is coincident with the recessed portion 18C of the inlet holder 18, the discharging hole 161 of the cap 160 is inserted while remaining facing upwards. However, since the discharging hole 161 of the cap 160 is closed by the ring-shaped cover 165 at this time, the cover 165 can also prevent the toner from leaking.

FIG. 6 is a plan view showing the state that the tip portion of the toner cartridge 16 engages the drive unit 20, which is viewed from the top of FIG. 5 to show the holder 21 and the toner cartridge 16 while the holder cover 22 is removed. This figure includes a cross section of only the holder guide 35 and the cover 165 of the cap 160. If the cartridge 16 is further inserted from the position shown in FIG. 6, the protruding portion 163 serving as the positioning portion engages the recessed portion 36b of the disk 36 to cause the tip end surface of the cap 160 to push the disk 36.

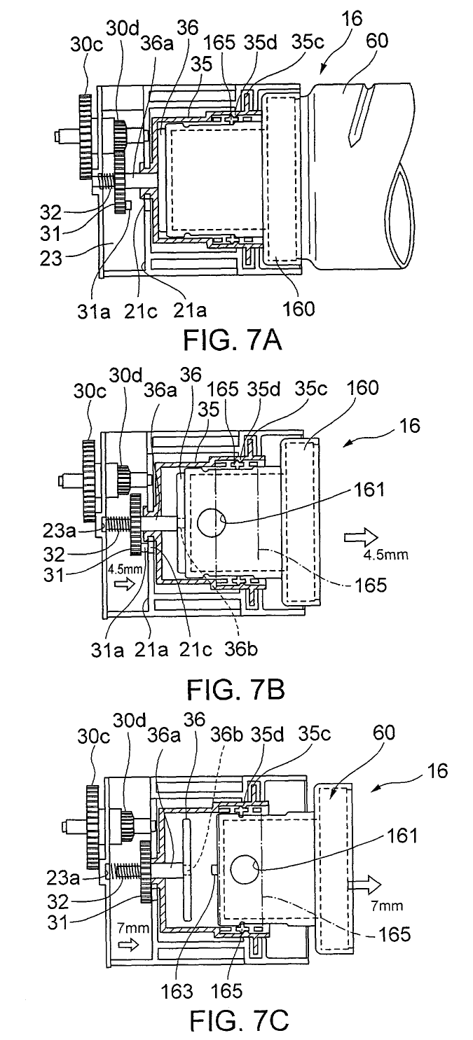

Slightly before this, the engaging protrusion 35d formed on the inner peripheral surface of the holder guide 35 engages the outer stopper 166b of the elastic tongue piece of the cover 165. Thus, the cover 165 slides while the protrusion 167 is guided by the guide groove 164 shown in FIG. 3, so that the discharging hole 161 is open. Thus, the discharging hole 161 is opened exactly in the holder guide 35, and the discharging hole 161 is coincident with the supply hole 35a of the holder guide immediately after the discharging hole 161 is open. In this state, the protrusion 31a of the gear set 31 engages the hole formed by the cut-out 21c of the holder 21 and the cut-out of the holder cover 22 facing the cut-out 21c. In FIG. 6, the cover 165 moves to the right with respect to the cap 160, so that the inner stopper 166a abuts on the engaging portion 162b. If the cartridge 16 is further thrust, the upper stopper 166b moves to the left in the figure to pass over the engaging protrusion 35d to a position shown in FIG. 7A.

Referring to FIG. 6 again, when the toner cartridge 16 is further thrust as described above, while the tip end surface of the cap 160 presses the disk 36 with the cylindrical portion 163 engaging the recessed portion 36b, the shaft portion 36a contacts the shaft receiving portion 23a against the spring force of the spring 32 to be positioned. In this state, the gear set 31 mounted on the shaft portion 36a meshes with the fourth gear 30d of the gear set 30. This state is shown in FIG. 7A. By driving the motor 26 in this state, the torque of the motor is transmitted by the drive mechanism 25 comprising the gear sets 30 and 31, and the cap 160 and the cylindrical container 60 can be rotated.

Referring to FIGS. 7A through 7C, the operation of detaching the toner cartridge by the drive unit 20 will be described below. In the conventional toner supply device, it is required to stop the rotation of the toner cartridge at a position, at which the discharging hole and the supply hole face upwards, so as to prevent the toner from leaking from the discharging hole of the cap and the supply hole of the holder guide and the like. However, in this embodiment of a toner supply device according to the present invention, the rotation of the toner cartridge 16 can be stopped even if the discharging hole 161 is arranged at any rotational positions.

That is, although the toner cartridge 16 can be stopped even if the supply hole 35a of the holder guide 35 and the discharging hole 161 of the cap 160 are arranged at any positions, the toner supply device of this embodiment is designed so that, when the toner cartridge 16 is intended to be detached in this state, it can be detached only after the protrusion of the gear set 31 engages the engaging hole which are formed by cut-out portion 32C of the partition of the holder 21 and the cut-out portion of the holder cover 22 corresponding to the cut-out portion 32C. Since the protrusion 31a is allowed to protrude by about 4.5 mm as indicated in FIG. 7B, the toner cartridge 16 is shifted by 4.5 mm in a direction indicated by a narrow when the protrusion 31a is fit in the hole formed by the cut-out 21c. The discharging hole 161 and the supply hole (not shown here but 35a in FIG. 4) face upwards while the protrusion 31a is being fit in the hole formed by the cut-out 21c. The 4.5 mm-movement of the toner cartridge 16 releases the gear 30d from engagement with the gear set 31 so that the toner cartridge 16 can rotate freely.

In this state, the discharging hole 161 of the toner cartridge 16 is gradually being closed by the cover 165 shown by the two-dot chain line in FIG. 7B. If this is further extracted, the discharging hole 161 is completely closed as shown in FIG. 7C, so that the discharging hole 161 can remain being closed when the toner cartridge 161 is extracted. In this state, if the disk 36 is further moved by 2.5 mm by the biasing force of the spring 32, the toner cartridge 16 is moved by “4.5+2.5=7 mm” toward the inlet holder 18 as shown in FIG. 7C. In this state, since the bottom portion of the toner cartridge 16 is protruded by at least 7 mm from the inlet holder 18, if the user holds and extracts the bottom portion of the cylindrical container 60 of the toner cartridge 16, the used toner cartridge 16 can be extracted.

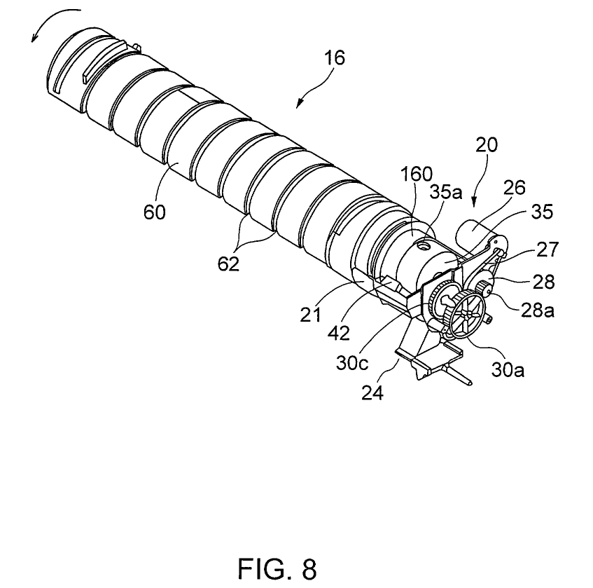

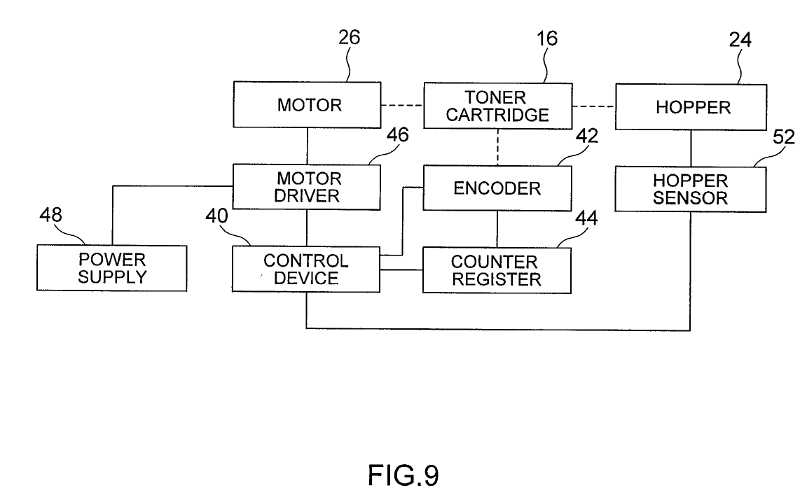

FIG. 8 is a perspective view illustrating the drive unit 20 including the holder 21, and the toner cartridge 16, for explaining the supply of toner to the developing device 11 from the toner supply device having the configuration disclosed above. In the toner supply device attached to the cartridge receiving portion 17, as described with reference to FIGS. 3 to 6, the motor 26 as a power driver of the drive unit 20 is controlled by a control device 40 (see FIG. 9) and the toner cartridge 16 is then rotated in a direction indicated by an arrow in the figure via the drive mechanism 25 such as gears. A hopper sensor 52 (not shown here but in FIG. 9) is installed in the hopper 24 to detect the remaining amount of supplied toner and to send a signal indicating a result of detection to the control device (not shown) so that a constant ratio of toner to carrier mixed is kept.

The rotation of the toner cartridge 16 causes the spiral protrusion formed in the container 60 to sequentially feed toner toward the supply hole 35a. In a regular use, toner is fed by a regular rotation in the direction indicated by the arrow. In toner-cartridge replacements, however, toner which may be unevenly distributed on the bottom of the cylindrical container 60 can be removed by repeating the regular rotation in the arrow directions and reverse rotation in a direction opposite to the arrow, alternately. On the partition wall 21a of the holder 21, an encoder 42 is provided, as shown in FIG. 8, for counting the rotation number of the toner cartridge 16 and detects a specific timing in which the discharging hole 161 approaches the supply hole 35a of the holder guide due to rotation of the toner cartridge 16 and also another specific timing in which the discharging hole 161 leaves the supply hole 35a of the holder guide after toner supply to the hopper 24. The encoder 42 has a sensor (not shown) that is turned on at an opening timing in which the discharging hole 161 is opened when the ring-shaped cover 165 slides due to rotation of the toner cartridge 16 whereas turned off at a closing timing in which the discharging hole 161 is closed when the cover 165 slides back after toner supply. The encoder 42 detects the timing in which the discharging hole 161 approaches the supply hole 35a and the other timing in which the discharging hole 161 has passed over the supply hole 35a, based on the sensor turn-on and -off states. The result of detection is offered to a counter register 44 (see FIG. 9) for counting each rotation of the toner cartridge 16.

Toner is fed out from the toner cartridge 16 through the discharging hole 161 and the supply hole 35a while the toner cartridge is rotating. The toner fed from the toner cartridge 16 is once stored in the carrier auger 33 of the holder 21 and fed towards the developing device 11 through the supply hopper 24 of the holder 21 by the carrier auger 32. Toner is once stored in the carrier auger 33 and fed therefrom, otherwise causing problems such as over toner or “fog” due to variation in the amount of toner per unit of time supplied through the discharging hole 161 of the toner cartridge 16 and the supply hole 35a. In detail, the carrier auger 33 carries toner while rotating in synchronism with the rotating toner cartridge 16 with engagement of the gear 30b, which is mounted thereon via the bush 34, with the gear 30a.

FIG. 9 is a block diagram showing a schematic configuration of the toner supply device in this embodiment with device elements for steady supply of a constant amount of toner to the developing device of the copying machine 1. The toner supply device in this embodiment has a motor driver 46 for driving the motor 26 in response to a command signal from the control device 40, the counter register 44 for accumulating and storing the rotation number of the toner cartridge 16 based on an output signal from the encoder 42 and a power supply 48 for supplying power to the motor driver 46 in addition to the control device 40, the motor 26, the hopper 24, the hopper sensor 52 and the encoder 42, already disclosed.

The encoder 42 is fixed at a particular position so that it will be located near the toner cartridge 16 when the cartridge is installed in the toner supply device, to detect the rotation number of the toner cartridge powered by the motor 26. The number of rotation of the toner cartridge 16 stored in the counter register 44 is reset whenever the cartridge is replaced with a new one. The counter register 44 counts up by one the rotation of the newly installed toner cartridge, thus counting and storing the total rotation number for each toner cartridge.

The hopper sensor 52 detects a ratio of toner to carrier mixed with each other in the hopper 24 and sends a signal indicating a result of detection to the control device 40. The control device 40 always monitors the input from the hopper sensor 52 to drive the motor 26 via the motor driver 46, when determining that toner should be fed in the hopper 24, to rotate the toner cartridge 16 with a rotary power from the motor 26, thus the hopper 24 being supplied with toner.

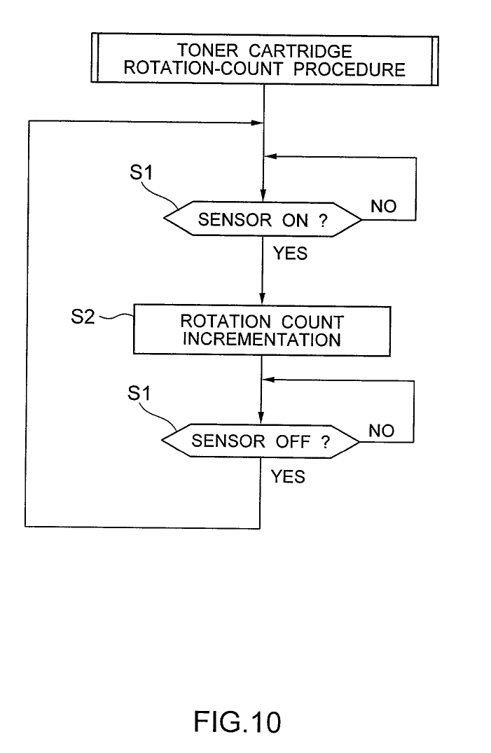

Disclosed next with reference to FIGS. 10 to 14 is an embodiment of method for steady supply of a constant amount of toner to the developing device of the copying machine 1.

FIG. 10 is a flowchart showing a procedure for counting the rotation number of the toner cartridge 16 by using the encoder 42. The counter register 44 performs incremental counting in accordance with alternate on and off states of the sensor of the encoder 42. The sensor's initial on state (step S1) of the sensor causes the counter register 44 to increase the count (step S2). The following off state (step S3) and the succeeding on state of the sensor (step S1) give determination that the toner cartridge 16 has rotated by 360 degrees, which causes the counter register 44 to increase the count (step S2).

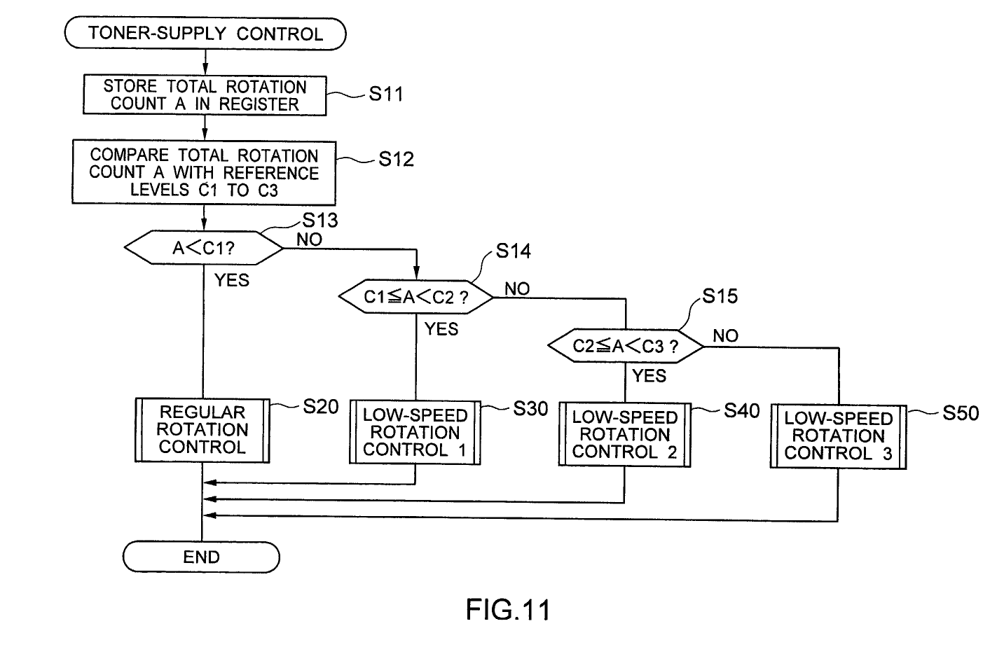

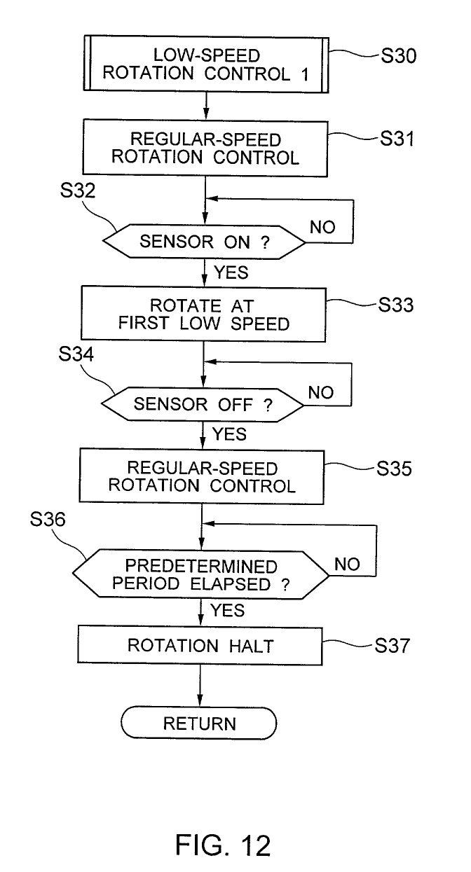

FIG. 11 is a flowchart showing a procedure for controlling the rotation of the motor 26 in accordance with an accumulated count value of the rotation number of the toner cartridge 16. FIGS. 12 to 14 are flowcharts showing the detailed procedures of low-speed rotation control 1, 2 and 3 which are shown in FIG. 11, respectively.

Some threshold levels are set initially, for determination of the amount of toner remaining in the toner cartridge 16. In this embodiment, the extent that could affect the amount of toner to be supplied to the hopper 24 is divided to four stages and each of the total number of rotation of the toner cartridge 16, which reaches the segment, is obtained by such as experiments to define each of the obtained numbers as three reference levels C1, C2 and C3 (C1<C2<C3) for determining whether it is enough for remaining toner.

Next, on installation of a new toner cartridge, the encoder 42 starts counting the rotation number of the toner cartridge 16 during toner supply, a total rotation count A being stored in the counter register (step S11).

When the control device 40 has determined that the developing device requires toner supply in response to an input from the hopper sensor 52, it compares the current total rotation count A with the reference levels C1, C2 and C3 (step S12).

As a result of the comparison, when the total rotation count A is lower than the reference level C1 (step S13) the control device 40 determines that an enough amount of toner remains in the toner cartridge 16, thus sending a control signal to the motor driver 46 so that the toner cartridge 16 can rotate at a regular speed V1 (step S20). The toner cartridge 16 then rotates at a constant speed of the V1 to discharge toner through the discharging hole 161 when it is positioned to face downwards, thus toner being supplied to the developing device via the hopper 24.

When the total rotation count A is equal to or higher than the reference level C1 as a result of the comparison (step S14), the control device 40 determines that toner in the toner cartridge 16 has been decreased a little, thus stating the first low-speed rotation control (low-speed rotation control 1) (step S30).

Moreover, when the total rotation count A is equal to or higher than the reference level C2 as a result of the comparison (step S15), the control device 40 determines that toner in the toner cartridge 16 has been decreased to a large degree, thus going on to the second low-speed rotation control (low-speed rotation control 2) (step S40).

Still, furthermore, when the total rotation count A is equal to or higher than the reference level C3 as a result of the comparison (step S15), the control device 40 determines that toner has been decreased to a substantial degree, thus going on to the third low-speed rotation control (low-speed rotation control 3) (step S50).

Disclosed next with reference to FIGS. 12 to 14 are detailed procedures for the low-speed rotation control 1, 2 and 3, respectively.

In the low-speed rotation control 1 shown in FIG. 12, the control device 40 starts to rotate the toner cartridge 16 at a regular rotational speed V1 (step S31). The sensor of the encoder 42 is turned on when the discharging hole 161 of the toner cartridge 16 has approached the supply hole 35a of the holder guide (step S32). Receiving a signal from the sensor, the control device 40 switches a control signal to the motor driver 46 to control the motor 26 so that the toner cartridge 16 can rotate at a speed V2 lower than the regular rotational speed V1 (step S33). This allows the discharging hole 161 of the toner cartridge 16 to pass over the supply hole 35a of the holder guide more slowly than in an operation of the regular supply, thus more toner being fallen into the supply hole 35a and supplied to the developing device of the copying machine 1 via the hopper 24.

When the sensor of the encoder 42 is tuned off after the rotational speed of the toner cartridge 16 has been decelerated from V1 to V2 (step S34), the control device 40 determines that toner supply will halt soon and sends a command signal to the motor driver 46 to return the rotational speed of the toner cartridge 16 from the first low speed V2 to the regular rotational speed V1 (step S35). The control device 40 waits then for a predetermined period of time to elapse (step S36) like a regular rotation-control procedure and subsequently brings the rotating toner cartridge 16 in a halt (step S37).

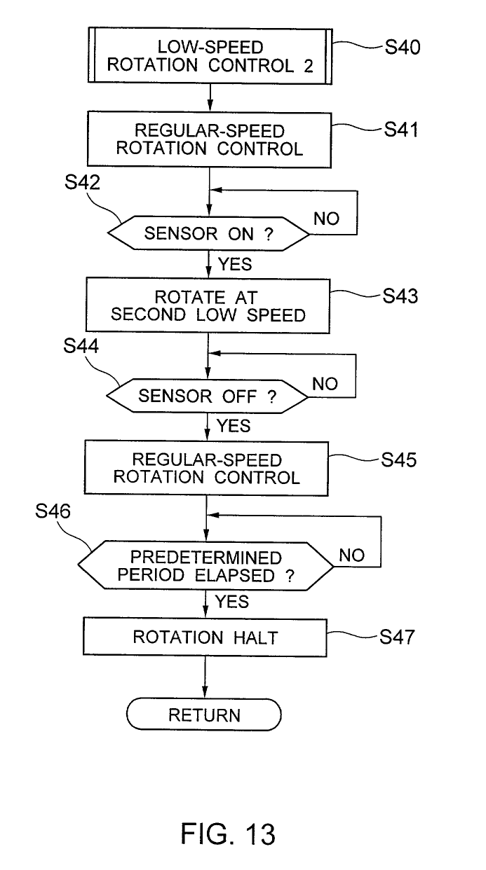

In the low-speed rotation control 2, as shown in FIG. 13, the control device 40 starts to rotate the toner cartridge 16 at the regular rotational speed V1 (step S41). The sensor of the encoder 42 is turned on when the discharging hole 161 of the toner cartridge 16 has approached the supply hole 35a of the holder guide (step S42). Receiving a detected signal from the sensor, the control device 40 switches a control signal to the motor driver 46 to control the motor 26 so that the toner cartridge 16 rotates at a rotational speed V3 lower than the regular rotational speed V1 and also the first low speed V2 (step S43). This allows the discharging hole 161 of the toner cartridge 16 to pass over the supply hole 35a of the holder guide much slower than in the low-speed rotation control 2, thus a lot more toner falling into the supply hole 35a and being supplied to the developing device of the copying machine 1 via the hopper 24.

When the sensor of the encoder 42 is tuned off after the rotational speed of the toner cartridge 16 has been decelerated from V1 to V3 (step S44), the control device 40 determines that toner supply will halt soon and sends a command signal to the motor driver 46 to return the rotational speed of the toner cartridge 16 from the second low speed V3 to the regular rotational speed V1 (step S45). The control device 40 waits then for a predetermined period of time to elapse (step S46) like the regular rotation-control procedure and sequentially brings the rotating toner cartridge 16 in a halt (step S47).

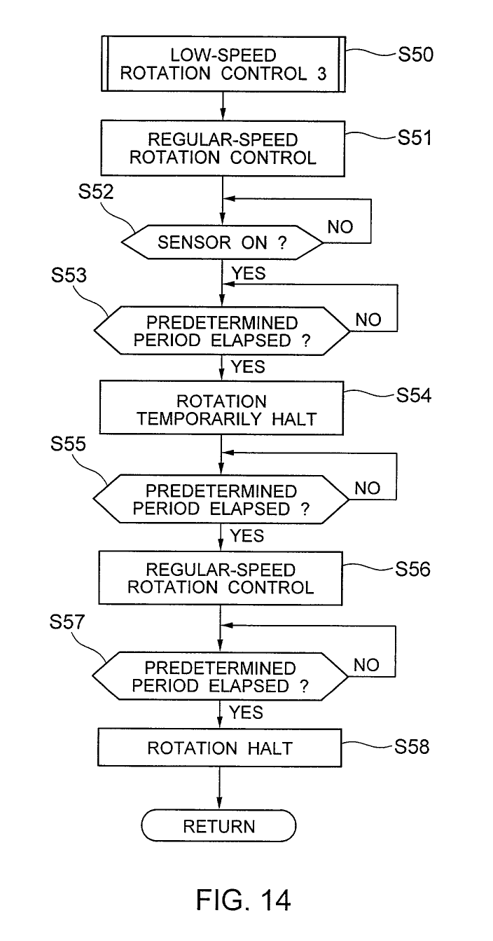

In the low-speed rotation control 3, as shown in FIG. 14, the control device 40 starts to rotate the toner cartridge 16 at the regular rotational speed V1 (step S51). The sensor of the encoder 42 is turned on when the discharging hole 161 of the toner cartridge 16 has approached the supply hole 35a of the holder guide (step S52). Receiving a detected signal from the sensor, the control device 40 sends a command signal to the motor driver 46 so that the motor 26 will cease rotation when a predetermined period of time elapses (step S53). This brings the rotating toner cartridge 16 in a halt so that the discharging hole 161 can stay just above the supply hole 35a of the holder guide (step S54), thus toner much more than in the second low-speed rotation control 2 being supplied to the developing device of the copying machine 1 via the hopper 24. When a predetermined period of time for toner supply has elapsed (step S55), the control device 40 sends a command signal to the motor driver 46 so that the toner cartridge 16 resumes rotation (step S56). The control device 40 waits then for a predetermined period of time to elapse (step S57) like the regular rotation-control procedure and sequentially brings the rotating toner cartridge 16 in a halt (step S58).

As disclosed above, according to this embodiment, the toner cartridge is controlled so that it will rotate slowly or cease the rotation only when toner is fallen from the toner cartridge. Thus, the embodiment achieves increase in toner supply in accordance with toner-supplying efficiency. Furthermore, the embodiment allows toner being scraped off when a little amount of toner has remained and been hardened on the inner surface of the toner cartridge since the toner cartridge is rotated while its rotational speed is being changed, thus achieving consumption of almost all toner in the toner cartridge. Moreover, according to the embodiment, the time period for one toner-cartridge rotation is not so different from the period for regular constant-speed rotation. Therefore, the embodiment solves a problem in toner supply in which a sufficient amount of toner could not be supplied in the end due to time-related factors in the known technique in which steady toner supply was attempted by increasing toner-cartridge rotation number.

The present invention is not limited to the embodiment disclosed above. For example, the embodiment estimates the amount of toner remaining in the toner cartridge based on an accumulated toner-cartridge rotation number in rotation-speed control. Then rotation-speed control over the toner cartridge 16 may, however, be achieved based on the amount of toner remaining in the hopper, for example. This modification offers steady toner supply to the developing device particularly for high-speed continuous formation of a large number of images and also formation of a single image but consuming a lot of toner. Another modification to the rotation-speed control over the toner cartridge 16 is based on a combination of estimation of the amount of toner remaining in the toner cartridge 16 and also the hopper. It is further understood by those skilled in the art that various modifications, changes and equivalents may be made in the invention without departing from the sprit and scope as set out in the accompanying claims.

What is claimed is:

1. A toner supply device used for an image forming system for forming images with toner, for supplying the toner to the image forming system from a toner cartridge having a cylindrical container, at least, a spiral protrusion being formed on the inner surface of the cylindrical container and a toner-discharging hole being formed on the outer surface of one of two capped end sections of the cylindrical container, the toner supply device comprising:
a cartridge holder which is installed in the image forming system to hold the toner cartridge in a horizontal direction, the toner cartridge being rotatable while held by said cartridge holder;
a rotation driver which supplies a rotary power to the toner cartridge, thus the toner being supplied to the image forming system through the toner-discharging hole due to a weight of the toner while the toner-discharging hole is facing downwards during rotation of the toner cartridge; and
a controller which controls said rotation driver to vary a rotational speed of the toner cartridge within one rotation in accordance with an amount of the toner remaining in the toner cartridge.

2. The toner supply device according to claim 1 further comprising a counter which counts a rotation number for each newly-installed toner cartridge,
wherein said controller monitors the amount of the toner remaining in the toner cartridge based on an accumulated count value counted by the counter, to control said rotation driver to vary a rotational speed of the toner cartridge within one rotation using the accumulated count value as a parameter.

3. The toner supply device according to claim 1, wherein said controller controls said rotation driver:
to rotate the toner cartridge constantly at a first rotational speed until the amount of the toner remaining in the toner cartridge reaches a first remaining amount that could affect an amount of toner supplied to the image forming system;
to rotate the toner cartridge at a second rotational speed lower than the first rotational speed when the toner-discharging hole has approached a position at which the toner is to be discharged through the toner-discharging hole as a result of rotation of the toner cartridge at the first rotational speed, after reaching the first remaining amount and until the amount of the toner remaining in the toner cartridge reaches a second remaining amount smaller than the first remaining amount, whereas rotate the toner cartridge at the first rotational speed again from the second rotational speed when the toner-discharging hole has passed over the position at which the toner is to be discharged through the toner-discharging hole and
to rotate the toner cartridge at a third rotational speed lower than the second rotational speed when the toner-discharging hole has approached the position at which the toner is to be discharged through the toner-discharging hole as a result of rotation of the toner cartridge at the first rotational speed, after reaching the second remaining amount but and the amount of the toner remaining in the toner cartridge reaches a third remaining amount, smaller than the second remaining amount, that could tremendously affect an amount of toner to be supplied to the image forming system, whereas rotate the toner cartridge at the first rotational speed again from the third rotational speed when the toner-discharging hole has passed over the position at which the toner is discharged through the toner-discharging hole.

4. The toner supply device according to claim 3, wherein said controller controls said rotation driver to bring the rotating toner cartridge in a halt for a specific period when the toner-discharging hole has reached the position at which the toner is to be discharged through the toner-discharging hole as a result of rotation of the toner cartridge at the first rotational speed, after the amount of the toner remaining in the toner cartridge has reached the third remaining amount, and to rotate the toner cartridge again at the first rotational speed when the specific period has elapsed.

5. The toner supply device according to claim 2, wherein said controller controls said rotation driver:
to rotate the toner cartridge constantly at a first rotational speed until the accumulated count value counted by the counter reaches a first count value indicating that the amount of the toner remaining in the toner cartridge could affect the amount of toner to be supplied to the image forming system;
to rotate the toner cartridge at a second rotational speed lower than the first rotational speed when the toner-discharging hole has approached a position at which the toner is to be discharged through the toner-discharging hole as a result of rotation of the toner cartridge at the first rotational speed whereas rotate the toner cartridge at the first rotational speed again from the second rotational speed when the toner-discharging hole has passed over the position at which the toner is to be discharged through the toner-discharging hole, after reaching the first count value and until the accumulated count value counted by the counter reaches a second count value larger than the first count value; and
to rotate the toner cartridge at a third rotational speed lower than the second rotational speed when the toner-discharging hole has approached the position at which the toner is to be discharged through the toner-discharging hole as a result of rotation of the toner cartridge at the first rotational speed whereas rotate the toner cartridge at the first rotational speed again from the third rotational speed when the toner-discharging hole has passed over the position at which the toner is to be discharged through the toner-discharging hole, after reaching the second count and until the accumulated count value counted by the counter reaches a third count value, larger than the second count value, indicating that the amount of the toner remaining in the toner cartridge could tremendously affect the amount of toner supplied to the image forming system.

6. The toner supply device according to claim 5, wherein said controller controls said rotation driver to bring the rotating toner cartridge in a halt for a specific period when the toner-discharging hole has reached the position at which the toner is to be discharged through the toner-discharging hole as a result of rotation of the toner cartridge at the first rotational speed, and to rotate the toner cartridge at the first rotational speed again when the specific period has elapsed, after the accumulated count value counted by the counter has reached third count value but.

7. A toner supply device used for an image forming system for forming images with toner, for supplying the toner to the image forming system from a toner cartridge having a cylindrical container with a spiral protrusion being formed at least on the inner surface of the cylindrical container and a toner-discharging hole being formed on the outer surface of one of two capped end sections of the cylindrical container, the toner supply device comprising:
a cartridge holder installed in the image forming system to hold the toner cartridge in a horizontal direction allowing the toner cartridge to be rotated;
a rotation driver to supply a rotary power to the toner cartridge, thus the toner being supplied to the image forming system through the toner-discharging hole due to a weight of the toner while the toner-discharging hole is facing downwards during rotation of the toner cartridge;
a hopper to be supplied with the toner due to a weight of the toner while the toner-discharging hole is facing downwards during rotation of the toner cartridge and to mix the toner with carrier at a specific mixing ratio, the mixed toner and carrier being supplied to the image forming system; and
a controller to control said rotation driver to vary a rotational speed of the toner cartridge within one rotation in accordance with an amount of the toner remaining in the toner cartridge.

8. The toner supply device according to claim 7 further comprising a counter to count a rotation number for each newly-installed toner cartridge,
wherein said controller monitors the amount of the toner remaining in the toner cartridge based on an accumulated count value counted by the counter, to control said rotation driver to vary a rotational speed of the toner cartridge within one rotation using the accumulated count value as a parameter.

9. The toner supply device according to claim 8, wherein said controller controls said rotation driver:
to rotate the toner cartridge constantly at a first rotational speed until the accumulated count value counted by the counter reaches a first count value indicating that the amount of the toner remaining in the toner cartridge could affect the amount of toner supplied to the hopper;
to rotate the toner cartridge at a second rotational speed lower than the first rotational speed when the toner-discharging hole has approached a position at which the toner is to be discharged to the hopper through the toner-discharging hole as a result of rotation of the toner cartridge at the first rotational speed whereas rotate the toner cartridge at the first rotational speed again from the second rotational speed when the toner-discharging hole has passed over the position at which the toner is to be discharged to the hopper through the toner-discharging hole, after reaching the first count value and until the accumulated count value counted by the counter reaches a second count value larger than the first count value; and
to rotate the toner cartridge at a third rotational speed lower than the second rotational speed when the toner-discharging hole has approached the position at which the toner is to be discharged to the hopper through the toner-discharging hole as a result of rotation of the toner cartridge at the first rotational speed whereas rotate the toner cartridge at the first rotational speed again from the third rotational speed when the toner-discharging hole has passed over the position at which the toner is to be discharged to the hopper through the toner-discharging hole, after reaching the second count but until the accumulated count value counted by the counter reaches a third count value, larger than the second count value, indicating that the amount of the toner remaining in the toner cartridge could tremendously affect the amount of toner to be supplied to the hopper.

10. The toner supply device according to claim 9, wherein said controller controls said rotation driver to bring the rotating toner cartridge in a halt for a specific period when the toner-discharging hole has reached the position at which the toner is to be discharged to the hopper through the toner-discharging hole as a result of rotation of the toner cartridge at the first rotational speed, and rotate the toner cartridge again at the first rotational speed when the specific period has elapsed, after the accumulated count value counted by the counter has reached third count value.

11. Atoner supply device used for an image forming system for forming latent images of desired images on an image-carrying body and developing the latent images into the desired images with toner supplied from a developing device onto the image-carrying body, for supplying the toner to the developing device from a toner cartridge having a cylindrical container with a spiral protrusion being formed at least on the inner surface of the cylindrical container and a toner-discharging hole being formed on the outer surface of one of two capped end sections of the cylindrical container, the toner supply device comprising:
a cartridge holder installed in the image forming system, which holds the toner cartridge in a horizontal direction allowing the toner cartridge to be rotated;
a rotation driver which supplies a rotary power to the toner cartridge;
a hopper which is supplied with the toner due to a weight of the toner while the toner-discharging hole is facing downwards during rotation of the toner cartridge and to mix the toner with carrier, the mixed toner and carrier being supplied to the developing device; and
a controller which controls said rotation driver to vary a rotational rotational speed of the toner cartridge in accordance with an amount of the toner remaining in the toner cartridge.

12. The toner supply device according to claim 11 further comprising a counter which counts a rotation number for each newly-installed toner cartridge,
wherein said controller monitors the amount of the toner remaining in the toner cartridge based on an accumulated count value counted by the counter, to control said rotation driver to vary a rotational speed of the toner cartridge within one rotation using the accumulated count value as a parameter.

13. The toner supply device according to claim 12, wherein said controller controls said rotation driver:
to rotate the toner cartridge constantly at a first rotational speed until the accumulated count value counted by the counter reaches a first count value indicating that the amount of the toner remaining in the toner cartridge could affect the amount of toner supplied to the developing device;
to rotate the toner cartridge at a second rotational speed lower than the first rotational speed when the toner-discharging hole has approached a position at which the toner is to be discharged to the developing device via the hopper through the toner-discharging hole as a result of rotation of the toner cartridge at the first rotational speed whereas rotate the toner cartridge at the first rotational speed again from the second rotational speed when the toner-discharging hole has passed over the position at which the toner is to be discharged to the developing device via the hopper through the toner-discharging hole, after reaching the first count value but until the accumulated count value counted by the counter reaches a second count value larger than the first count value; and
to rotate the toner cartridge at a third rotational speed lower than the second rotational speed when the toner-discharging hole has approached the position at which the toner is to be discharged to the developing device via the hopper through the toner-discharging hole as a result of rotation of the toner cartridge at the first rotational speed whereas rotate the toner cartridge at the first rotational speed again from the third rotational speed when the toner-discharging hole has passed over the position at which the toner is to be discharged to the developing device via the hopper through the toner-discharging hole, after reaching the second count and until the accumulated count value counted by the counter reaches a third count value, larger than the second count value, indicating that the amount of the toner remaining in the toner cartridge could tremendously affect the amount of toner supplied to the hopper.

14. The toner supply device according to claim 13, wherein said controller controls said rotation driver to bring the rotating toner cartridge in a halt for a specific period when the toner-discharging hole has reached the position at which the toner is to be discharged to the developing device via the hopper through the toner-discharging hole as a result of rotation of the toner cartridge at the first speed, and rotate the toner cartridge again at the first rotational speed when the specific period has elapsed, after the accumulated count value counted by the counter has reached third count value.

15. Atoner supply method used for an image forming system for forming images with toner, for supplying the toner to the image forming system from a toner cartridge having a cylindrical container with a spiral protrusion being formed at least on the inner surface of the cylindrical container and a toner-discharging hole being formed on the outer surface of one of two capped end sections of the cylindrical container, the toner supply method comprising the steps of:
supplying a rotary power to the toner cartridge, thus the toner being supplied to the image forming system through the toner-discharging hole due to a weight of the toner when the toner-discharging hole is facing downwards during rotation of the toner cartridge; and
varying a rotational speed of the toner cartridge within one rotation in accordance with an amount of the toner remaining in the toner cartridge.

16. The toner supply method according to claim 15 further comprising the step of counting a rotation number for each newly-installed toner cartridge,
wherein the amount of the toner remaining in the toner cartridge is estimated based on an accumulated count value for the rotation number of the toner cartridge, and a rotational speed of the toner cartridge is varied using the accumulated count value as a parameter.

17. The toner supply method according to claim 15 further comprising the steps of:
rotating the toner cartridge constantly at a first rotational speed until the accumulated count value counted by the counter reaches a first count value indicating that the amount of the toner remaining in the toner cartridge could affect the amount of toner supplied to the image forming system;
rotating the toner cartridge at a second rotational speed lower than the first rotational speed when the toner-discharging hole has approached a position at which the toner is to be discharged through the toner-discharging hole as a result of rotation of the toner cartridge at the first rotational speed whereas rotate the toner cartridge at the first rotational speed again from the second rotational speed when the toner-discharging hole has passed over the position at which the toner is to be discharged through the toner-discharging hole, after reaching the first count value and until the accumulated count value counted by the counter reaches a second count value larger than the first count value; and
rotating the toner cartridge at a third rotational speed lower than the second rotational speed when the toner-discharging hole has approached the position at which the toner is to be discharged through the toner-discharging hole as a result of rotation of the toner cartridge at the first rotational speed whereas rotating the toner cartridge at the first rotational speed again from the third rotational speed when the toner-discharging hole has passed over the position at which the toner is to be discharged through the toner-discharging hole, after reaching the second count and until the accumulated count value counted by the counter reaches a third count value, larger than the second count value, indicating that the amount of the toner remaining in the toner cartridge could tremendously affect the amount of toner supplied to the image forming system.

18. The toner supply method according to claim 17, wherein the toner cartridge is brought in a halt for a specific period when the toner-discharging hole has reached the position at which the toner is to be discharged through the toner-discharging hole as a result of rotation at the first rotational speed and rotated again at the first speed when the specific period has elapsed, after the accumulated count value has reached third count value.
